(19) United States
(12) Patent Application Publication
(10) Pub. No.: US 2010/0300257 A1
(43) Pub. Date: Dec. 2, 2010

(54) MACHINE TOOL

(76) Inventors: Andreas Loewe, Lahstedt (DE); Ingo Herrmann, Friolzheim (DE); Klaus Marx, Stuttgart (DE); Wolfgang Niehsen, Bad Salzdetfurth (DE); Thilo Koeder, Gerlingen (DE); Georg Stellmann, Ludwigsburg (DE); Joachim Platzer, Remseck-Hochberg (DE); Sebastian Jackisch, Ludwigsburg (DE)

Correspondence Address: KENYON & KENYON LLP, ONE BROADWAY, NEW YORK, NY, 10004, US

(21) Appl. No.: 12/733,765

(22) PCT Filed: Jul. 22, 2008
(86) PCT No.: PCT/EP2008/059554

§ 371 Date: Aug. 16, 2010

(30) Foreign Application Priority Data
Sep. 20, 2007 (JP) 102007044801.7

(51) Int. Cl. B23D 45/04; B23Q 11/06

(52) U.S. Cl. 83/360; 83/471.2; 83/478

(57) ABSTRACT

A machine tool, e.g., a sawing machine, has a work surface for placing a workpiece to be machined, and a tool support unit for supporting a tool, the unit being supported movably relative to the work surface. The machine tool includes a tool operation monitoring device for monitoring a tool range at least during a tool operation, which monitoring device includes an imaging unit.

### BACKGROUND OF THE INVENTION

1. Field of the Invention

The present invention is directed to a machine tool.

2. Description of Related Art

A miter saw is known which has a workbench, a support unit for rotary support of a saw blade, and a lowerable arm which may be actuated by an operator for moving the support unit relative to the workbench.

### BRIEF SUMMARY OF THE INVENTION

The present invention is directed to a machine tool having a work surface for placing a workpiece to be machined, and a tool support unit for supporting a tool which is supported movably relative to the work surface.

It is proposed that the machine tool includes a tool operation monitoring device having an imaging unit for monitoring a tool range at least for a tool operation. In this manner a particularly high level of safety may be achieved in the operation of the machine tool. It is particularly advantageous that high reliability in monitoring the tool range may be achieved by use of the imaging unit, in particular when the tool support unit moves relative to the work surface. The machine tool advantageously has a support unit which is used to movably support the tool support unit relative to the work surface and to connect the tool support unit to the work surface. The machine tool advantageously has a guide unit which is provided for guiding the tool support unit. The machine tool also preferably includes an actuating unit which is provided for an operator to set the tool support unit into motion relative to the work surface. For the motion of the tool support unit, a tool supported therein is guided from a starting position to at least one working position in which the tool contacts the workpiece. In the present context, a “tool range” refers in particular to a range composed of points having a minimum distance of 10 cm maximum, advantageously 5 cm maximum, and preferably 2 cm maximum, from a tool and/or a tool extension range of the machine tool. A “tool extension range” is composed in particular of points which may potentially be occupied by a tool, in particular due to the movable support of the tool support unit for supporting the tool relative to the machine tool work surface. The imaging unit has a field of vision which during operation advantageously establishes a monitored range of the machine tool. The monitored range preferably includes at least a portion of the tool range. The vertical projection of the monitored range on the work surface advantageously includes the vertical projection of the tool range on the work surface. The monitored range may also include at least one partial range of the tool extension range.

It is further proposed that the tool operation monitoring device has an evaluation unit which is provided in the tool range for recognizing the presence of a human body part on the basis of recorded image data.

It is further proposed that the machine tool has a carrier means which is used to carry along at least one detection means of the imaging unit in a motion of the tool support unit relative to the work surface. A high level of safety, in particular when a tool support unit moves, may thus be achieved.

A particularly compact design of the machine tool may be achieved when the machine tool has a protective device for covering a tool, to which at least one detection means of the imaging unit is fastened.

Alternatively or additionally, it is proposed that the machine tool has a guide unit to which at least one detection means of the imaging unit is fastened, thus allowing components and installation space to be saved.

It is further proposed that the tool support unit is provided for the rotational support of a tool in a plane of rotation, and the imaging unit has detection means situated laterally to the plane of rotation, thus allowing advantageous lateral monitoring of the tool. A system “lateral” to the plane of rotation refers in particular to a system in a half-space which is delimited by the plane of rotation. Complete embedding in this half-space is to be understood in particular. A “plane of rotation” refers in particular to a plane which contains the center of gravity of the tool and is oriented perpendicular to a rotational axis of the tool. The detection means is particularly preferably situated laterally to the tool. The projection of the detection means is situated on the tool perpendicular to the plane of rotation, preferably embedded in a tool surface.

In typical use of the machine tool, the hands of an operator are situated on either side of a tool, one hand operating an actuating unit and the other hand being placed on a workpiece. In this regard, a high level of safety may be achieved when the machine tool has an actuating unit for an operator moving the tool support unit relative to the work surface, and the actuating unit and detection means are situated on either side of the plane of rotation.

In one advantageous refinement of the present invention, it is proposed that the machine tool has a safety means which is provided to prevent a motion of the tool support unit relative to the work surface on the basis of a signal of the tool operation monitoring device, so that contact of a supported tool with an undesired object or human body part present in a tool extension range may advantageously be avoided.

A rapid and reliable detection function on the basis of recorded image data may be achieved when the tool operation monitoring device has an image processor which is provided for evaluating at least one feature from the group composed of color, contour, and texture. It is particularly advantageous to provide the evaluation unit for recognizing an application situation by comparing image data to previously stored data of sample images.

The tool operation monitoring device advantageously has an image processor which is provided for ascertaining on the basis of recorded image data a path of motion of an object moving in the tool range. It is thus possible to quickly recognize a hazard potential during operation of the machine tool. It is particularly advantageous when the image processor is provided for extrapolating the path of motion to a future position of the object relative to the tool.

In one advantageous refinement of the present invention, it is proposed that the tool operation monitoring device has an image processor which is provided for ascertaining on the basis of recorded image data a rate of speed of an object moving in the tool range. In this regard, great flexibility in use of the machine tool may be achieved when the tool operation monitoring device has at least two safety modes, each being assigned to a particular rate of speed.

### BRIEF DESCRIPTION OF THE SEVERAL VIEWS OF THE DRAWING

FIG. 1 shows a miter saw having a tool operation monitoring device integrated into a safety cover, in a side view.

FIG. 2 shows the miter saw from FIG. 1 in a top view.

FIG. 3 shows a saw blade and a tool range of the miter saw in a front view.

FIG. 4 shows a circuit having a sensor unit, an evaluation unit, and safety means for blocking a motion of the saw blade.

FIG. 5 shows a hand of a user in the tool range.

FIG. 6 shows a hand of a user in the tool range at two different points in time, and the determination of a path of motion of the hand of a user.

FIG. 7 shows a hand of a user in the tool range at two different points in time.

FIG. 8 shows a subdivision of the tool range, having a warning range and an actuator range.

FIG. 9 shows the miter saw with the tool operation monitoring device situated in a guide unit.

### DETAILED DESCRIPTION OF THE INVENTION

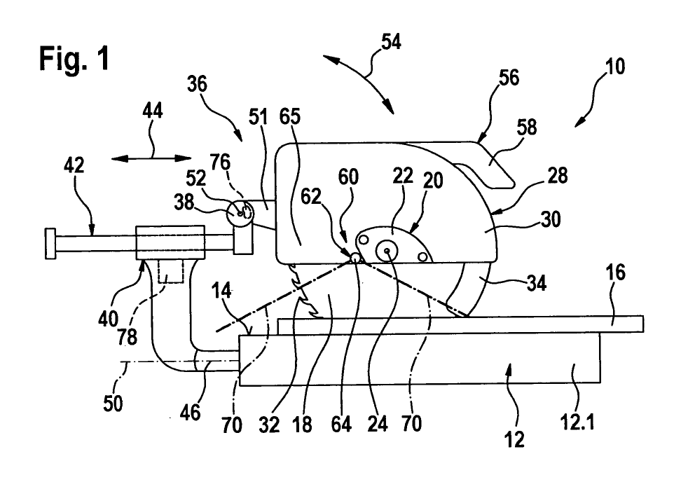

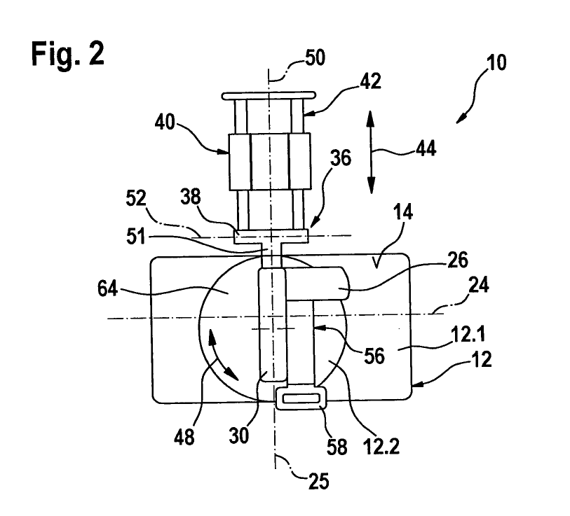

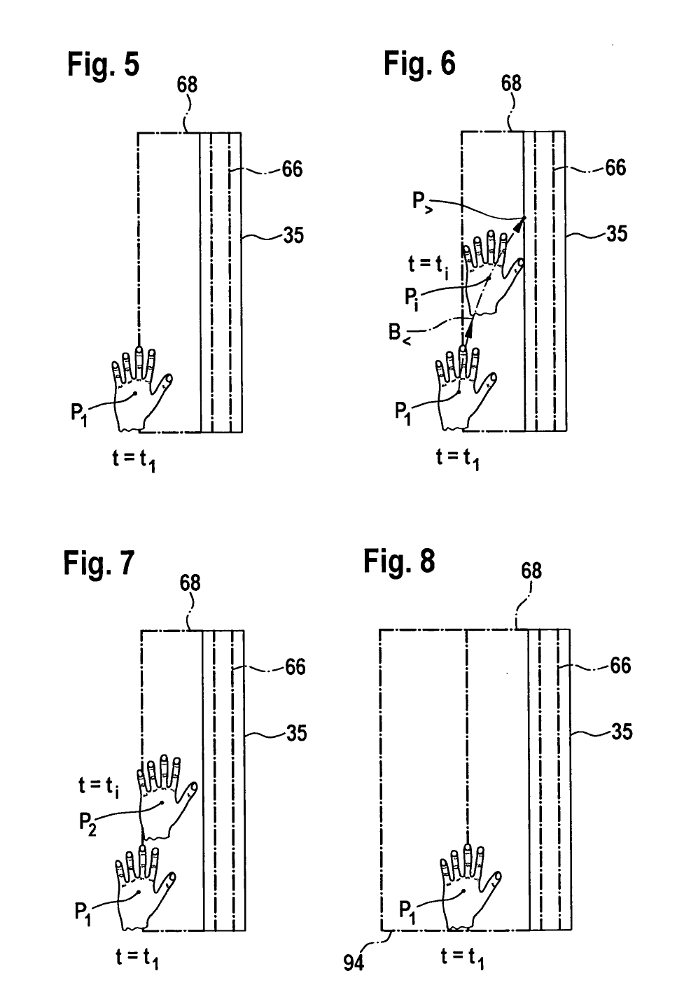

FIG. 1 shows a machine tool 10 designed as a stationary device, in particular as a miter saw, in a side view. The following description also refers to FIG. 2, which illustrates machine tool 10 from FIG. 1 in a top view. Machine tool 10 may also be designed as a compound miter saw or crosscut saw. Machine tool 10 has a workbench 12 which forms a work surface 14 which is provided for placing, for example laying or mounting, a workpiece to be machined with the aid of machine tool 10. As shown in FIG. 2, workbench 12 has a first component 12.1, which is fixedly connected to a stop area or support device (not illustrated in detail) for stopping or supporting workbench 12, and a second, circular component 12.2 which is supported rotatably relative to component 12.1 about an axis perpendicular to work surface 14. In FIG. 1, a workpiece 16, in the form of a wooden board, to be sawn is placed on work surface 14. When workpiece 16 is machined, machine tool 10 includes a tool 18 designed as a circular saw blade. A tool support unit 20 for machine tool 10 is provided for supporting tool 18. Tool support unit 20 has support means 22 which is used to support tool 18 rotatably about a rotational axis 24. Tool support unit 20 thus defines a plane of rotation 25 for tool 18 which contains the center of gravity of tool 18 and is perpendicular to rotational axis 24. When workpiece 16 is machined, tool 18 is driven with the aid of a drive unit 26 designed as an electric motor for rotation about rotational axis 24. To protect an operator from contacting tool 18, machine tool 10 is equipped with a protective device 28 in the form of a safety cover. This protective device has a main element 30 which covers a cutting edge 32 of tool 18 over at least one-half the circumference of the cutting edge, and has an auxiliary element 34 which is movable relative to main element 30 and which may be moved as the result of contact with workpiece 16. As shown in FIG. 1, tool support unit 20 is fastened to protective device 28. Component 12.2 also has an opening 35, shown in FIG. 5, which is provided for insertion of tool 18.

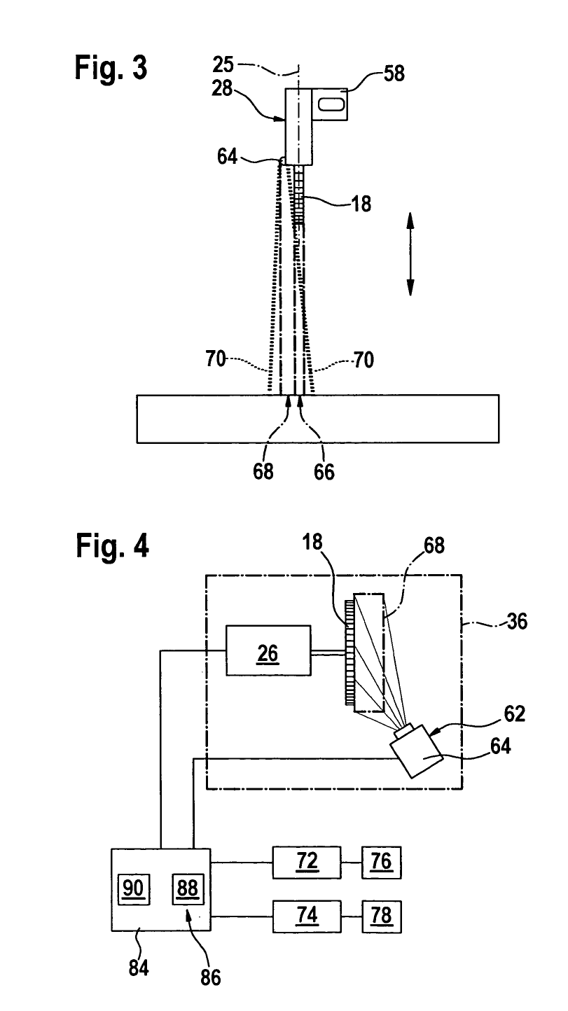

Tool 18, tool support unit 20, drive unit 26, and protective device 28 are components of a tool unit 36 which is supported movably relative to workbench 12 and in particular relative to component 12.1. For this purpose, machine tool 10 has a first support unit 38 which is provided for supporting tool unit 36 movably relative to work surface 14. Tool unit 36 may be rotated about a horizontal rotational axis 52, oriented parallel to rotational axis 24, with the aid of support unit 38 and a lowerable arm 51. Thus, tool 18, starting from a neutral position shown in FIG. 3, may be brought into the lower working position shown in FIG. 1, along a curved path of motion 54, and placed on workpiece 16 to be machined.

Support unit 38 itself is supported movably relative to workbench 12. For this purpose machine tool 10 has a second support unit 40. Support unit 40 is designed as a holding unit which is provided for holding and passing through a guide unit 42. This guide unit 42, which is fixedly connected to support unit 38, is used, in cooperation with support unit 40, to guide tool unit 36 and support unit 38 in a linear direction of motion 44 parallel to work surface 14 and perpendicular to rotational axis 52. Tool unit 36 and support unit 38 may perform horizontal translational motions relative to work surface 14. Guide unit 42 has two guide means which are designed as guide rods and which pass through support unit 40. Support unit 40 is fastened to workbench 12, in particular to movable component 12.2 thereof, via a partial range 46. Support units 38, 40 and tool unit 36 may be rotated in a rotational direction 48 about an axis which is perpendicular to work surface 14 and is centrally situated in workbench 12. Support unit 40 itself may be designed to be movable relative to workbench 12, in particular relative to component 12.2. In particular, the support unit is able to perform swivel motions about an axis of inclination 50 which is oriented horizontally and parallel to direction of motion 44, thus enabling tilting motions of tool unit 36 relative to work surface 14. For this purpose tool 18 may be tilted starting from an orientation perpendicular to work surface 14.

The motion of tool support unit 20 relative to work surface 14 may be actuated by the operator. For this purpose machine tool 10, in particular tool unit 36, is provided with an actuating unit 56. This actuating unit has a handle 58 which is provided for gripping by one hand of an operator. In this manner the motion of tool unit 36 along horizontal direction of motion 44 and the motion of tool unit 36 about rotational axis 52 along path of motion 54 in the direction of work surface 14, and vice versa, may be actuated by the operator. Lowerable arm 51 is spring-loaded, so that when actuating unit 56 is released the tool unit automatically returns to the neutral position shown in FIG. 3. Actuating means (not illustrated in detail) for starting a drive of tool 18 is integrated into handle 58. For operating machine tool 10, the operator grips handle 58 with one hand while typically placing the other hand on workpiece 16. To prevent the hand of an operator from contacting rotating tool 18, machine tool 10 is provided with a safety device which has a tool operation monitoring device 60. This is achieved with the aid of an imaging unit 62, which includes detection means 64, illustrated in the figure as a dashed-dotted line, as a video camera for recording images at least in the visible spectrum. Detection means 64 is fixedly connected to tool unit 36, in particular to tool support unit 20. Detection means 64 is fastened to protective device 28, in particular to main element 30 thereof. Protective device 28 is used as carrier means 65, which is provided for carrying along detection means 64 during any motion of tool support unit 20 relative to work surface 14.

FIG. 3 shows tool unit 36 together with protective device 28, tool 18, handle 58, and detection means 64 in the neutral position of tool unit 36, in a front view. As described above, tool unit 36 may be moved to a lower working position with the aid of actuating unit 56. The mobility of tool 18 establishes a tool extension range 66 which corresponds to a spatial range which potentially may be occupied by tool 18. Tool extension range 66 is illustrated by vertical dashed-dotted lines. Due to the mobility of tool 18, tool extension range 66 likewise extends in direction of motion 44, in the horizontal direction perpendicular to the plane of the drawing. Tool operation monitoring device 60 is used to monitor a tool range 68. This tool range 68 adjoins tool extension range 66, and is composed of points having a minimum distance of 2 cm maximum from tool extension range 66. Tool range 68 to be monitored is situated laterally to plane of rotation 25, and in particular faces away from actuating unit 56, in particular handle 58, relative to plane of rotation 25. Tool range 68 and actuating unit 56 are situated on either side of plane of rotation 25. Tool extension range 66 and tool range 68 are schematically delimited by dashed-dotted lines. Detection means 64 has a field of vision 70, shown by single-dash lines in FIG. 3 (also see FIG. 1), which defines a monitored range of machine tool 10 which includes a significant portion of tool range 68. As shown in FIG. 3, the monitored range may also include a portion of tool extension range 66. For monitoring tool range 68, detection means 64 is situated laterally to tool 18, in particular on a side of plane of rotation 25 facing away from actuating unit 56, in particular facing away from handle 58. Actuating unit 56 and detection means 64 are situated on either side of plane of rotation 25.

The safety device also has actuator units 72, 74 which are provided for carrying out safety measures in cooperation with tool operation monitoring device 60. This is illustrated in greater detail in FIG. 4, which shows a schematic view of a circuit having imaging unit 62, actuator units 72, 74, and drive unit 26 coupled to tool 18. Actuator units 72, 74 are provided for driving safety means 76, 78, respectively. Safety means 76, schematically illustrated in FIG. 1, is a blocking means designed as a clamping means, and is situated in the region of rotational axis 52. Safety means 76 is situated in particular in support unit 38. Safety means 76 is used for preventing a rotational motion of tool unit 36, actuated by the operator, about rotational axis 52, i.e., a motion of tool 18 along path of motion 54. Safety means 76 is spring-loaded in a position which enables this motion. Actuator unit 72 is used to bring safety means 76, from this position which enables the motion, to a blocking position which blocks the motion, and to actuate a return of safety means 76 to its enabling position. Safety means 78, likewise schematically illustrated in FIG. 1, is situated in support unit 40 and is used for preventing a translational motion of a tool unit 36, actuated by the operator, along direction of motion 44. Safety means 78 is likewise a blocking means designed as a clamping means, and may be actuated with the aid of actuator unit 74. In this regard, reference is made to the description of safety means 76.

Actuator units 72, 74 trigger an actuation of safety means 76 and 78, respectively, as a function of a signal of tool operation monitoring device 60, in particular, a signal of an evaluation unit 84 for tool operation monitoring device 60. For this purpose evaluation unit 84 is operatively linked to actuator units 72, 74. Evaluation unit 84 is provided for evaluation of image data recorded by imaging unit 62, and for this purpose is operatively linked to imaging unit 62. Evaluation unit 84 has an image processor 86 which includes evaluation means 88, designed as a microprocessor, and a memory unit 90 which is provided for storing an image processing program. Image processor 86 is used in particular to recognize the presence of a human body part in tool range 68 on the basis of image recordings which are recorded with the aid of detection means 64. For this purpose, with the aid of the image processing program a recorded image may be examined for a texture which is typical of human tissue and/or of a typical article of clothing worn by an operator, a protective glove, for example. Detection may also be carried out with the aid of color analysis of an image by examining the image for a color which is typical of human skin. A recorded image may also be evaluated with the aid of contour analysis or contour extraction, in which the image is examined for a contour which is typical of a hand.

FIG. 5 shows a partial range of workbench 12 together with opening 35 provided in rotatable component 12.2, as well as the contour of tool range 68 to be monitored and of tool extension range 66, in a top view. After recognizing the presence of a human body part in tool range 68, in particular a hand of an operator as illustrated in FIG. 5, position P₁ of the hand at a point in time t₁ relative to tool extension range 66 is ascertained. Detection means 64 continuously detects images of tool range 68 at successive points in time. The image data are evaluated in real time by continuously evaluating the detected sequence with the aid of evaluation unit 84. In this regard, the recorded images may be consecutively evaluated. In the example considered in FIG. 6, the hand of an operator is located in a position Pᵢ at a later point in time tᵢ. A sequence of images (not illustrated in the figure for the sake of clarity) may be recorded between points in time t₁ and tᵢ. By ascertaining the various positions of the hand of an operator between P₁ and Pᵢ, evaluation means 88 ascertains path of motion B_{<} of the hand of an operator. On the basis of this path of motion B_{<} which has been traversed by the hand of an operator before the instantaneous detection point in time tᵢ, evaluation means 88 determines an expected position P_{>} for the hand of an operator at a later point in time t_{>}. Path of motion B_{<} ascertained on the basis of recorded images is extrapolated to future position P₂₂ with the aid of evaluation means 88.

Evaluation unit 84 is also provided for ascertaining a rate of speed of the detected hand of an operator in the tool range on the basis of images recorded at various points in time. This is described with reference to a comparison of FIGS. 6 and 7. As described above, the hand of an operator in FIG. 6 is located in a position Pᵢ at a point in time tᵢ. In the example considered in FIG. 7, the hand of an operator is moved in the tool range at a greater speed. At the same point in time tᵢ, the hand of an operator is located in a position P₂ in front of position Pᵢ. Evaluation means 88 determines a rate of speed on the basis of a comparison of the positions ascertained at the two points in time t₁ and tᵢ. For example, a hand motion may be associated with a speed level “fast,” “moderately fast,” “slow,” etc.

The triggering of safety measures in various safety modes is elucidated. It is assumed that the operator intends to lower the rotating tool from the neutral position shown in FIG. 3 to the lower working position shown in FIG. 1 via a rotational motion about rotational axis 52, with the aid of actuating unit 56. It is also assumed that the location of the operator's left hand in tool range 68 is determined with the aid of evaluation unit 84. In a first safety mode of the safety device, the recognition of the presence of the hand of an operator in tool range 68 automatically triggers the actuation of actuator unit 72 by transmitting a signal of evaluation unit 84 to actuator unit 72. In this manner the lowering motion of tool 18 is prevented by safety means 76. A rate of speed of the hand of an operator is ascertained in two further safety modes. If the motion is identified as a “slow” motion, in one safety mode the operator is warned with the aid of an optical and/or acoustic output device. The path of motion of the hand of an operator is continuously analyzed. If the path of motion or an extrapolated path of motion leads to tool extension range 66, actuation of actuator unit 72 is triggered. If the motion is identified as a “fast” motion, for, example when the hand of an operator slips on a workpiece surface, in a further safety mode actuator unit 72 is immediately actuated. A further safety mode provides for the changing of the rotational speed of the rotating tool 18 as a safety measure. For this purpose, evaluation unit 84 is operatively linked to drive unit 26. For warning the operator, the rotation of tool 18 may be slowed on the basis of a signal of evaluation unit 84. In a further safety level, tool 18 is automatically stopped on the basis of a signal of evaluation unit 84.

It is further proposed that imaging unit 62 is provided for monitoring a further mode range 94 in addition to tool range 68. This is illustrated in FIG. 8. Tool range 68 and mode range 94 are each associated with a different safety mode, which is carried out when the presence of a human body part in tool range 68 or in mode range 94 is recognized by evaluation unit 84. Thus, for example, tool range 68 may correspond to an actuator range which directly adjoins tool extension range 66 and in which the above-described safety modes may be activated with the aid of actuator unit 72 or 74. Mode range 94, which adjoins tool range 68 and is situated in the direction of rotational axis 24 on plane of rotation 25, in front of tool range 68, may correspond to a warning range. If evaluation unit 84 recognizes the presence of a human body part in mode range 94, evaluation unit 84 triggers a warning signal to warn the operator. Tool range 68 and mode range 94 may be monitored by detection means 64, or two different detection means may be provided for imaging unit 62 for monitoring tool range 68 and for monitoring mode range 94.

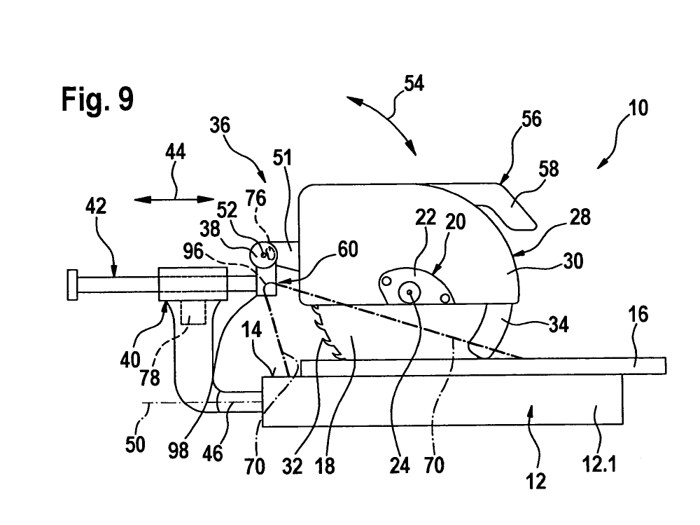

FIG. 9 shows an alternative design of machine tool 10. Components which remain the same are denoted by the same reference numerals. The following description is limited to the differences from the design described above. In this alternative, imaging unit 62 has detection means 96 designed as a video camera. This detection means is integrated into guide unit 42, in particular in a partial range beneath support unit 38. This partial range is used in particular as a stop for blocking a motion of the guide means through support unit 40. Guide unit 42 is used as carrier means 98, which is used for carrying along detection means 96 during a translational motion of tool support unit 20 in direction of motion 44. For a design of machine tool 10 in which drive unit 26 and actuating unit 56 are situated on either side of plane of rotation 25, drive unit 26 then projecting beyond tool range 68 to be monitored, detection means of imaging unit 62 may be fastened to a housing of drive unit 26. Combinations of the above-described systems of detection means are likewise possible.

1-10. (canceled)

11. A machine tool configured as a sawing machine, comprising:
a work surface configured to support a workpiece to be machined;
a tool-support unit configured to movably support a tool relative to the work surface; and
a tool-operation monitoring device configured to monitor a tool range at least during operation of the tool, wherein the monitoring device includes an imaging unit.

12. The machine tool as recited in claim 11, further comprising:
a carrier unit;
wherein the imaging unit includes at least one detection unit, and wherein the carrier unit is configured to transport the at least one detection unit for the imaging unit in a motion of the tool-support unit relative to the work surface.

13. The machine tool as recited in claim 12, further comprising:
a protective device for covering the tool, wherein the at least one detection unit for the imaging unit is fastened to the protective device.

14. The machine tool as recited in claim 12, wherein the carrier unit is configured as a guide unit, and wherein the at least one detection unit for the imaging unit is fastened to the guide unit.

15. The machine tool as recited in claim 12, wherein the tool-support unit is configured to provide a rotational support for the tool in a plane of rotation, and wherein the at least one detection unit of the imaging unit is situated laterally to the plane of rotation.

16. The machine tool as recited in claim 15, further comprising:
an actuating unit configured to provide motion of the tool-support unit relative to the work surface, wherein the actuating unit and the detection unit are situated on opposite sides of the plane of rotation.

17. The machine tool as recited in claim 12, further comprising:
a safety unit configured to prevent, on the basis of a signal of the tool-operation monitoring device, a motion of the tool-support unit relative to the work surface.

18. The machine tool as recited in claim 12, wherein the tool-operation monitoring device has an image processor for evaluating at least one of color, contour and texture.

19. The machine tool as recited in claim 12, wherein the tool-operation monitoring device has an image processor for ascertaining, on the basis of recorded image data, a path of motion of an object moving in the tool range.

20. The machine tool as recited in claim 12, wherein the tool operation monitoring device has an image processor for ascertaining, on the basis of recorded image data, a rate of speed of an object moving in the tool range.
